(19) United States
(12) Patent Application Publication
(10) Pub. No.: US 2010/0218642 A1
(43) Pub. Date: Sep. 2, 2010

(54) COOLING OIL CIRCULATION OF A MOTOR-VEHICLE TRANSMISSION WITH A CONTROL VALVE

(75) Inventors: Horst LEICHSENRING, Hohentengen (DE); Olaf LANGWALD, Neukirch-Bernried (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/706,841

(22) Filed: Feb. 17, 2010

(30) Foreign Application Priority Data
Mar. 2, 2009 (DE) 10 2009 001 264.8

(51) Int. Cl. F16H 57/04

(52) U.S. Cl. 74/606 A

(57) ABSTRACT

An oil cooling circulation for a vehicle transmission comprising a transmission enclosure (1) having an input pipeline (2) and a return pipeline (3) for oil exchange between the inner area of the transmission and an oil cooler. A control valve (5) is provided which, by activation of a pre-loaded valve part (6) sliding along a center line of the control valve (5), the return pipeline (3) can be coupled with the supply input line (2). The valve part (6) has, at the return pipeline (3), a pin shaped top part and the transmission enclosure (1) has a borehole (4), penetrating the supply input line (2) and the return pipeline (3), in which the control valve (5) is positioned. The valve part (6) of the control valve (5) is slidingly positioned between a borehole bottom and a provided supporting part (10; 10′; 10″; 10′″) in the estuary of the borehole (4).

This application claims priority from German patent application serial no. 10 2009 001 264.8 filed Mar. 2, 2009.

### FIELD OF THE INVENTION

The invention relates to an oil cooling circulation in a motor vehicle transmission, in particular an automatic transmission, comprising a transmission enclosure having an input pipeline and a return pipeline for the exchange of oil between an inner area and an oil cooler, positioned outside of the transmission enclosure whereby, between the oil cooler and the inner area, a control valve is provided in which, by activation of a sliding valve part along the longitudinal centerline of the control valve and preloaded by a return spring, the return pipeline can be coupled with the input pipeline whereby the valve part, at the part of the return pipeline, has a pin shaped top part.

### BACKGROUND OF THE INVENTION

Usually, transmission oil is applied in motor vehicle transmissions to influence, among other things, the frictional value pattern of the clutches which reside in the transmission, influence the dissipation of heat and lubricate the meshing gears as well as the bearings, or to activate the clutches and/or brakes which are positioned in the motor vehicle. The transmission oil of automatic transmissions also transfers hydro-dynamically the force of the torque converter or the engine retarder. However, the surface of the transmission housing is, in the last named case, often not sufficiently dissipate the existing heat of the transmission oil. For that reason, oil coolers are often provided for automatic transmissions through which the temperature of the transmission oil is again regulated downward to acceptable values.

In the particular oil cooling circulation, when connecting the enclosure of the transmission with the oil cooler on the outside of the enclosure, control valves are often applied, on an as needed basis, to regulate the supplied amount of transmission oil.

A control valve is known, through DE 10 2006 003 271 A1, where the enclosure has connections, on one hand, to link input and output pipelines of a transmission enclosure and, on the other hand, has input and output pipelines for an oil cooler. A spring loaded valve is provided, inside of the control valve, which has a pin shaped top part, at the side of the return pipeline and along the longitudinal line of the control valve, which is designed as a thermostatic work part and which changes its length, depending on the oil temperature passing thereby. When the transmission oil is cool, the valve part is moved into a position, due to the adjusted and relatively short length of the pin shaped top part, and by the additionally mounted return spring, in which the connection between the return line from the transmission enclosure to the input pipeline of the oil cooler is shut and, at the same time, the return pipeline is connected with the input pipeline of the transmission enclosure. Correspondingly, the transmission oil does not flow through the oil cooler but flows, through the hereby formed bypass, again directly back into the transmission. During an increase of the oil temperature, a pin shaped top part changes its length and hereby moves the valve part, through the support of the axial facing limiter of the control valve, against the return spring and eventually closes the bypass, whereby this axial movement is limited by a spacer part on the other side of the valve part. Hereby, the transmission oil flows through the input pipeline into the oil cooler and, thereafter, through the outlet and the return pipeline, at a down regulated temperature, again into the inside of the transmission enclosure.

It is generally known that such a control valve can be positioned within an oil cooling circulation of a motor vehicle transmission, between a transmission enclosure and an oil cooler to connect an inner area of a transmission enclosure and with the oil cooler, through input and return pipelines. Hereby, the control valve is positioned with its own enclosure in the area outside of the transmission enclosure.

It is disadvantageous, in such embodiment of an oil cooling circulation, that an appropriate installation space has to be provided, in the area of the motor vehicle transmission, for the enclosure of the control valve, which has to be connected with pipes, thereby increasing the need for space in this area as well as increasing the production cost.

### SUMMARY OF THE INVENTION

Therefore, it is the task of this invention to create an oil cooling circulation for a motor vehicle transmission in which placement of a control valve, in the area of the transmission enclosure, can be achieved by lowering space requirements in this area and reducing the manufacturing cost.

The task is accomplished through the characteristic features of claim 1, referring to the specific characteristics. The following dependent claims list the respective, advantageous additional embodiments of this invention.

The invention relates to the technical teaching that the transmission enclosure has a borehole which penetrates the input pipeline and the return pipeline, in which the control valve is placed. Hereby, the valve part of the control valve is located between a bottom of the borehole and a supporting part placed in the estuary of the borehole. Through this measure, an additional enclosure for the control valve can be saved because it is formed by the surrounding transmission enclosure and the supporting part. In addition, pipelines can be omitted to connect the transmission enclosure with the control valve which results in a significant total reduction of the manufacturing cost. Also, due to the integration of the control valve within the transmission enclosure, the required installation space can be reduced.

As an additional embodiment of this invention, the pin shaped top part is designed as a thermostatic work part. The advantage is that shifting of the valve part, and therefore the coupling of the return pipeline with the input pipeline of the transmission enclosure, can be controlled depending on the temperature of the transmission oil and the related change in length of the work part.

In accordance with an alternative embodiment of the invention, the pin shaped top part is designed as a rigid part. Hereby, the control valve can be used as a pressure controlled valve in the area of the transmission enclosure whereby, under normal operating conditions of the oil cooling circulation, the transmission oil flows through the oil cooler while, at a high pressure in the return line, for instance due to a very low temperature of the transmission oil and a related high viscosity, a shifting of the valve part is initiated, followed by the coupling of the return pipeline with the input pipeline.

In accordance with an advantageous embodiment of this invention, an input or output pipeline of the oil cooler is provided, at the front of the valve part and at the estuary area of the borehole, whereby the supporting part has at least one opening. The advantage is that one of the two pipelines of the oil cooler can also be positioned in the area of the borehole and provided to accommodate the control valve, thereby enabling the appropriate, additional embodiments and matching it with the available installation space conditions in the area of the transmission enclosure.

In the embodiment of the invention, the supporting part is designed as a circular shaped part which has at least one bar, which extends through the centerline. At first, through this measure, a support surface is created for the return spring or the pin shaped top part while, at the same time, a sufficient cross-sectional flow is available for the exchange of the transmission oil.

In accordance with another advantageous embodiment, at least one bar, facing away from the valve element, is designed as a bent shaped. In another embodiment, at least one bar, facing toward the valve element, is designed as a bent shaped. Hereby, the cross-sectional flow is advantageously further enlarged and the pressure drop minimized in this area.

It is an embodiment of the invention the at least one bar has a receptacle positioned in the center line of the circular shaped part. Therefore, a slipping of the pin shaped top part can be prevented and, therefore, also a tilting of the entire valve part can be precluded.

It is a further embodiment of the invention that the circular shaped part is designed as extending in the axial direction. Through this extension of the circular shape part, and therefore similar to a sleeve design of the supporting part, a pipeline, running radial to the part, can be selectively closed. In this case, the supporting part can also be applied as control part.

Preferably, the axial extension of the circular shaped part is designed as a sealing part. The advantage is that, in case of a contact of the supporting part with the valve element, an unwanted flow of transmission oil through the supporting part can be effectively prevented without using additional parts.

In accordance with an additional advantageous embodiment of the invention, the supporting part is secured in the borehole by a snap ring, positioned on the side, facing away from the valve part. Hereby, the supporting part is advantageously and reliably maintained in its position.

### BRIEF DESCRIPTION OF THE DRAWINGS

Additional features, further improving the invention, are presented in the following description and preferred embodiments of the invention by means of the drawings.

It shows:

FIG. 1 is a perspective cross section view of the invented oil cooling circulation, in the area of a transmission enclosure, in accordance with the first embodiment;

FIG. 2 is a perspective cross section view of the invented oil cooling circulation, in the area of the transmission enclosure, in accordance with the second embodiment;

FIG. 3 is a perspective, detailed view of a supporting part from FIG. 2;

FIG. 4 is a perspective detailed view of the invented oil cooling circulation, in the area of the control valve, in accordance with a third embodiment; and

FIG. 5 a detailed section view of the invented oil circulation in the area of the control valve, in accordance with a fourth embodiment.

### DETAILED DESCRIPTION OF THE PREFERRED EMBODIMENTS

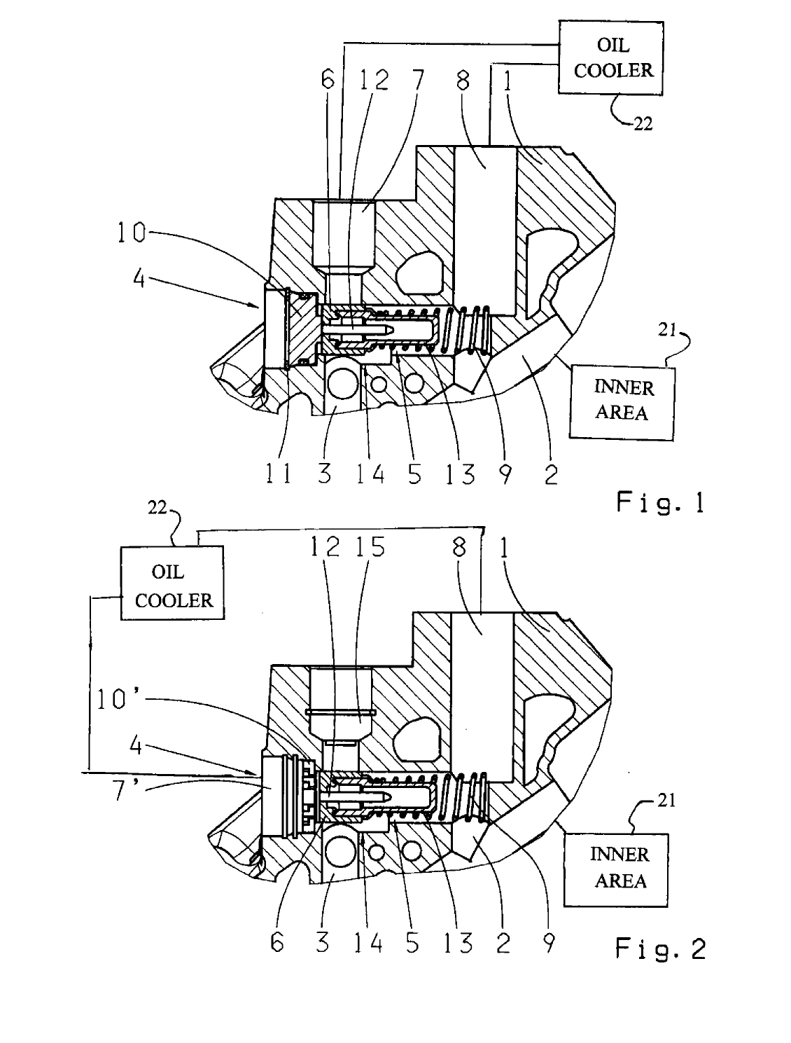

In FIG. 1, a perspective view of the invented oil cooling circulation can be seen, in accordance with the first embodiment, in the area of a transmission housing 1 in which a input pipeline 2 and a return pipeline 3 are presented, to connect an inner area 21 with an oil cooler 22. A control valve 5 has been placed in the borehole 4 of the transmission enclosure 1, which connects the input pipeline and the output pipeline 2 and 3, according to the position of a valve part 6, with an inlet 7 and an outlet 8 of the oil cooler, to control the amount of transmission oil supplied into the oil cooler. By a return spring 9, this valve part 6 is preloaded against a support part 10, which is secured in the borehole 4 by a snap ring 11 and has, on its side facing the return pipeline 3, a pin-shaped top part in form of a thermostatic work part 12. Depending on its temperature, this thermostatic work part 12 changes its length and hereby initiates the related sliding of the valve part 6. The valve part 6 is also fixedly mounted, on its inside, by a spacer part 13, which allows movement of the valve part 6 towards the return spring 9, only in accordance with its axial length.

The presented operating situation in FIG. 1 of the control valve 5 shows that the valve part 6, by the return spring 9, has been moved completely toward the support part 10, whereby transmission oil cannot flow into the inlet 7 of the oil cooler, but, starting from the return pipeline 3, flows back into the input pipeline 2. The borehole 4 has a step 14, in this area, to enable this reflow past the valve part 6. An increase of the temperature of the transmission oil, flowing through the supply return line 3, now causes a change in length of the thermostatic work part 12 and hereby it slides the valve part 6 in the axial direction against the return spring 9, supported by the support part 10. In an extreme case, this movement is limited by contact of the spacer part 13 with the bottom of the borehole 4 whereby the valve part 6, in this position, enables the flow of the transmission oil into the inlet 7 and, at the same time, disables the return flow into the return pipeline 2. Therefore and in this case, the transmission oil flows completely through the oil cooler. Within these two extreme positions, the supply of the transmission oil to the oil cooler and a return flow into the inside occurs continuously in accordance with the longitudinal expansion of the thermostatic work part 12.

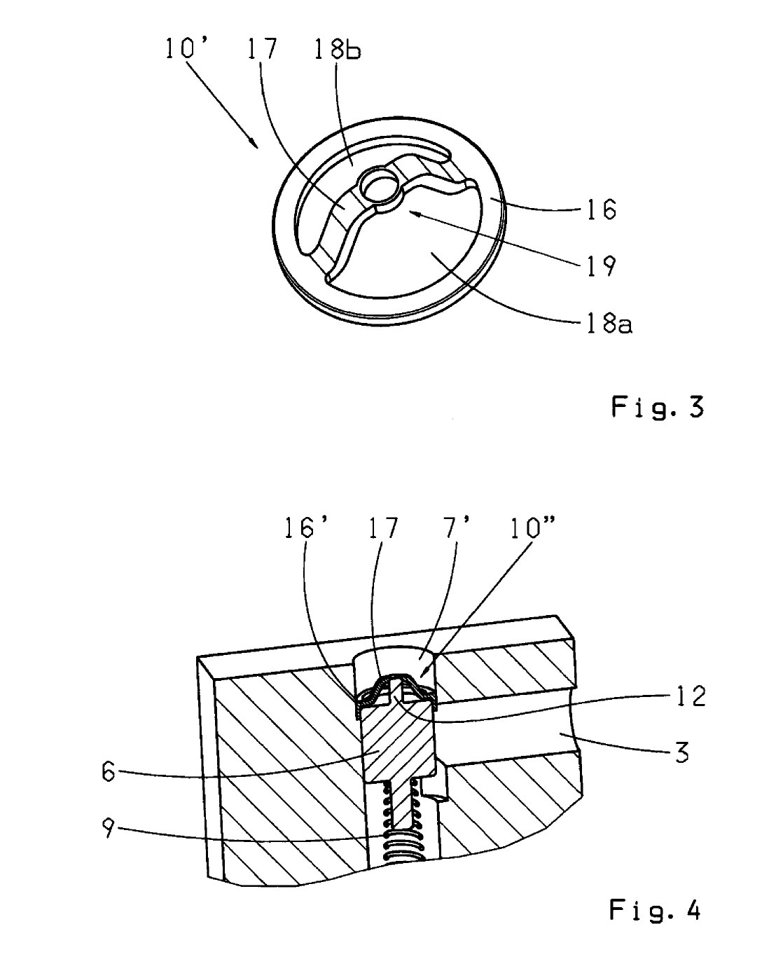

FIG. 2 shows a perspective partial view of the invented oil cooling circulation in accordance with a second embodiment. Different from the presented variation in FIG. 1, the inlet 7′ out the oil cooler is positioned at the front side of the valve part 6 and in the estuary of the borehole 4. Hereby, on the other side of the control valve 5 a continuation of the return pipeline 3 is closed by a plug 15. To enable a flow of the transmission oil now into the inlet 7′ of the oil cooler, the support part 10′ is constructed as in FIG. 3. One can recognize that in FIG. 3 the support part 10′ has a circular shaped part 16 with a bar 17, which extends through the centerline of the circular shaped part 16 and hereby defines two openings 18A and 18B. This bar 17 also has, in the axial direction, a bent design and has one receptacle 19, on the centerline of the circular shaped part 16, which is positioned for a contact with the thermostatic work part 12, not shown here.

FIG. 4 presents a detailed sectional view of the invented oil cooling circulation, in accordance with a third embodiment and presented in the area of the control valve 5. Different from the two previously described embodiments, the circular shaped part 16′ has an axial extension through which the borehole cross section of the return pipeline 3 becomes partially closed and through which an oil stream is reduced, when coupled with the inlet 7′ of the oil cooler.

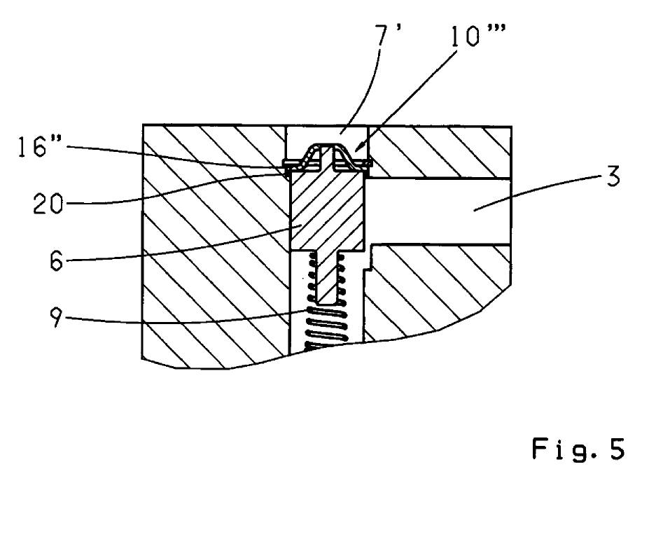

Finally, another fourth embodiment of the oil cooling circulation can be seen in FIG. 5, in which the circular shaped part 16″ of the supporting part 10′″ has an axial extension designed as a sealing part 20. When the valve part 6 abuts against the support part 10′″, a flow of transmission oil from the supply return line 3 into the inlet 7′ of the oil cooler will be effectively prevented by this sealing part 20.

It is possible, through the previously described embodiments of the invented oil cooling circulation, to achieve a very compact configuration in the area of the transmission enclosure 1 and to control, at the same time, the exchange of transmission oil between the oil cooler and the transmission housing.

### REFERENCE CHARACTERS

1 Transmission Enclosure
2 Input Pipeline
3 Return Pipeline
4 Borehole
5 Control Valve
6 Valve Part
7 7, 7′ Inlet
8 Outlet
9 Return Spring
10, 10′, 10″, 10′″ Supporting Part
11 Snap Ring
12 Thermostatic Work Part
13 Spacer Part
14 Step
15 Plug
16 16, 16′, 16″ Circular Support Part
17 Bar
18 18A, 18B Openings
19 Receptacle
20 Sealing Part
21 Inner Area
22 oil Cooler

1-10. (canceled)

11. An oil cooling circulation of a motor vehicle transmission comprising a transmission enclosure (1) having an input (2) pipeline and a return pipeline (3) to exchange oil between an inside of the transmission and an oil cooler, positioned outside of the transmission housing (1), a control valve (5) being positioned between the oil cooler and the inside area of the transmission housing (1), and by activation of a valve part (6), pre-loaded by a return spring (9) and sliding along the longitudinal center line of the control valve (5), the supply return line (3) can be linked with the input pipeline (2) whereby the valve part (6), at the return pipeline (3), has a pin shaped top part,
wherein the transmission enclosure (1) further comprises a penetrating borehole (4) which penetrates the input pipeline (2) and the return pipeline (3) and the control valve (5) is positioned therein, and the valve part (6) of the control valve (5) is slidingly positioned between a borehole bottom and a supporting part (10; 10′; 10″; 10′″) in the estuary area of the borehole.

12. The oil cooling circulation according to claim 11, wherein the pin shaped top part is a thermostatic work part (12).

13. The oil cooling circulation according to claim 11, wherein the pin shaped top part is a rigid part.

14. The oil cooling circulation according to claim 11, wherein that one of an inlet (7′) and an outlet to the oil cooler is positioned at a front of the valve part (6) and in the estuary area of the borehole (4), and the supporting part (10′; 10″; 10′″) has at least one opening (18A, 18B) formed therein.

15. The oil cooling circulation according to claim 14, wherein the supporting part (10′; 10″. 10′″) is formed by a circular shaped part (16; 16′; 16″) which has at least one bar (17) which passes through a center line thereof.

16. The oil cooling circulation according to claim 15, wherein that at least one bar (17) has a bent shape.

17. The oil cooling circulation according to claim 15, wherein at least one bar (17) has a receptacle (19) therein which is located along the centerline of the circular shaped part (16; 16′; 16″).

18. The oil cooling circulation according to claim 15, wherein the circular shaped part (16′; 16″) extends in an axial direction and forms an axial extension.

19. The oil cooling circulation according to claim 15, wherein the circular shaped part (16′; 16″) extends in an axial direction and forms an axial extension, and the axial extension is a sealing part (20).

20. The oil cooling circulation according to claim 11, wherein the supporting part (10; 10′; 10″; 10′″) is secured in the borehole (4) by a snap ring (11) positioned at an opposite side of the valve part (6).
